(19) United States
(12) Patent Application Publication
(10) Pub. No.: US 2024/0040448 A1
(43) Pub. Date: Feb. 1, 2024

(54) METHOD OF MAINTAINING 4G RADIO CONNECTIVITY AND USING 5G SERVICE

(71) Applicant: VIETTEL GROUP, Ha Noi City (VN)

(72) Inventors: Thi Xuan Hoa Ho, Ha Noi City (VN); Truong Giang Le, Ha Noi City (VN); Kim Anh Dung Pham, Ha Noi City (VN); Ngoc Tuan Do, Ha Noi City (VN); Thi Huyen Trang Le, Ha Noi City (VN); Duy Linh Vu, Ha Noi City (VN); Thu Phuong Nguyen, Ha Noi City (VN)

(73) Assignee: VIETTEL GROUP, Ha Noi City (VN)

(21) Appl. No.: 18/347,399

(22) Filed: Jul. 5, 2023

(30) Foreign Application Priority Data
Jul. 29, 2022 (VN) 1-2022-04833

(51) Int. Cl. H04W 36/00; H04W 36/36

(52) U.S. Cl. CPC H04W 36/00698; H04W 36/36; H04W 36/008357; H04W 36/0058; H04W 36/0072

(57) ABSTRACT

The invention provides the method that allows UE to simultaneously use 4G and 5G technology when handover from a eNodeB station to eNodeB ENDC base station that supports data transfer on 5G technology platform effectively and optimize deployment costs for current carriers. The method can be widely applied on software and hardware available.

### TECHNICAL FIELD

The patent related to the method of maintaining radio connectivity and 5G service of user equipment (UE) during the transfer from the 4G technology base station (source eNodeB station) to the target base station (target eNodeB station) which will be connected to the 5G technology base station (gNodeB station) on the dual-connected mobile technology platform (Dual Connectivity) in the 4^{th} and 5^{th} generation.

### Technical Status of the Invention

The 5th generation mobile technology (5G) shows the ability to provide high-speed data for UE with the fact that the current number of UE is very large and increasing strongly.

However, the actual requirements for mobile network operators in providing 5G services to users are: With the number of UE supporting 5G technology in the first phase is limited, the number of sacrifices 5G cells will not be widely popular and there will be holes in the coverage of 5G network. Solutions for operators can provide seamless services for 5G devices by combining with long-term 4G network currently (4G-5G Dual Conectivity-Endc technology).

The concern of UE 5G is to ensure the connection during the UE process moving from the coverage of eNodeB station to the coverage of other eNodeB station. Currently, the 3GPP standard system has come up with the solution for the case of signal and data transfer of UE mentioned above, which is: Information transmission of UE (UE Context) at the source eNodeB station will be sent to the target eNodeB station by handover procedure. Simultaneously, the target eNodeB station carries out the connection procedure with GNB at the same time. However, this method is only suitable when the process of transferring dual radio from 4G station to 4G station is capable of connecting to 5G station to ensure the delay time does not exceed 1 ms.

In fact, the current network operators need to develop and optimize a lot to achieve the requirements of the above handling time because the complexity of the procedure needs to be handled. Moreover, with the solution of 3GPP, UE's battery energy consumption for the measurement process for necessary information (Measurement Report) as a basis for selecting the target eNodeB station with the ability to connect to 5G station will not be small. The invention provides a method to solve these mentioned existing disadvantages and easily deployed for carriers to use in combination with both 4G and 5G technology platforms (4G -5G Dual Conectivity-ENDC).

### Technical Nature of the Invention

When the signal quality between UE and eNodeB station is impaired, to ensure the connection between UE and the network, the eNodeB station will perform the handover connection procedure to other eNodeB station by triggering A5 event. The method of the invention is to perform the handover procedure, then get the information of UE and request the measurement of B1 event. After that, the target eNodeB station select the most suitable 5G station based on resulting measurement report. Finally, the eNodeB station will proceed to activate the sgnb addition procedure with the gNodeB station until the success. Because the procedure of transferring connection from the source eNodeB station to the target eNodeB station is now with a delay period that allows up to hundreds of ms, it will ensure the rate of drop/data interruption is extremely low. Once the UE is in the coverage and connected to the target eNodeB station, the station will choose the destination gNodeB station with the best data transmission quality for UE at the coming position immediately. Thus, the method has advantages: always ensure the quality of UE using 5G service at a high level, connecting between UE and the network is continuous, saving battery for UE because it is not necessary to measure B1 event so many times and easy to deploy with the small number of 5G stations and we can take advantage of the available 4G network infrastructure.

To achieve the above goal, the patent proposes a new solution for the case of UE to transfer from source eNodeB station to the target eNodeB station having connection with a gNodeB station, including:

Step 1: Measure the signal quality of 4G eNodeB neighbors and select a best eNodeB to handover.

UE is in a connected state with the source eNodeB. The eNodeB synthesizes the list of eNodeB neighbors and asks UE to send signal quality measurement reports at frequencies through the A5 event. The source eNodeB found that the quality of UE signals decline, the source eNodeB selects a target eNodeB station having good signal quality for UE to carry out the connection procedure.

Step 2: the source eNodeB activates the UE connection procedure to the target eNodeB.

The source eNodeB start the handover procedure from source 4G eNodeB to target eNodeB until success.

Step 3: The eNodeB chooses a 5G gNodeB. The step includes the following small steps:

The target eNodeB checks the ability to support the dual connectivity technology (4G-5G Dual Conectivity-ENDC). If the station has support, request UE to provide the 5G technology support information;

The target eNodeB receives a response, if the UE supports 5G technology, the eNodeB station will activate the measurement of B1 event, by sending information frequency of neighboring 5G stations to request UE to measure signal quality;

UE sends the measurement report to the target eNodeB following the B1 event;

The target eNodeB receives measurement information and select the eligible gNodeB station:
In the list of Neighbor NR Cell (Neighbor NR Cell) of the target eNodeB station;
The best signal quality for UE.

After this step, the selected 5G gNodeB station will be named by “the target gNodeB”.

Step 4: the target eNodeB conducts the SGNB Addition Procedure to the target gNodeB;

At the end of the processing flow, UE exchanges control signals via the target eNodeB station and using the service provided by the target gNodeB.

### BRIEF DESCRIPTION OF DRAWINGS

FIG. 1 is an overview description of the ENDC network structure;

FIG. 2 is a general drawing description of the transfer process from the source eNodeB to the target eNodeB station and using data of the target gNodeB;

FIG. 3 is a figure describing the signal quality measurement procedure through A5 event;

FIG. 4 is a drawing describing a newsletter that requires UE to provide 5G technology;

FIG. 5 is a drawing describing the signal quality measurement procedure for 5G gNodeB through B1 event;

FIG. 6 is a drawing describing the status of UE at the target eNodeB;

FIG. 7 is a drawing describing the model of testing the method given at Viettel-VHT.

### DETAILED DESCRIPTION OF THE INVENTION

The following section clearly and fully describes the technical solution of the invention. In which, professional terms are defined as follows:
Data plane (Data Plane): The blocks are responsible for processing the data newsletter.
Control Plane: The blocks are in charge of processing the signaling information
Event A5—Event activates the measurement function when the quality signal of the serving cell becomes inferior to the threshold 1 (Threshold1) and the neighboring cell's signal quality has better the level threshold 2 (threshold2);
Event B1—Event activates signal measurement function when the signal quality of neighboring networks is not the same technology (Inter Rat Neighbor) becomes better than threshold;

The invention offers a method that is easy to deploy at 4G service providers that can combine 5G services for the transfer procedure from a source eNodeB to a target eNodeB station having connection with target gNodeB.

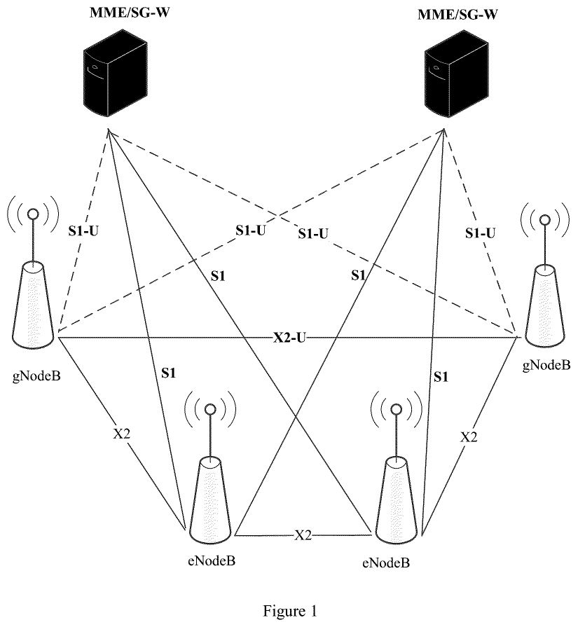

FIG. 1 in general describes the ENDC system when carriers deployed combining 4G and 5G technology. UE exchanged information with both 4G eNodeB and 5G gNodeB as simultaneously. However, all communication (control and data signals) go through the core network of 4G (MME). For data plane (Data Plane), both eNodeB and gNodeB exchange data directly with the core network in turn to MME and S-GW via S1 interface and S1-U interface respectively. For the control plane (Control Plane), only eNodeB will exchange information directly with the core network MME via S1interface. Communication between eNodeB and gNodeB/eNodeB connected via the X2 interface, between gNodeB and gNodeB connected via the X2-U interface.

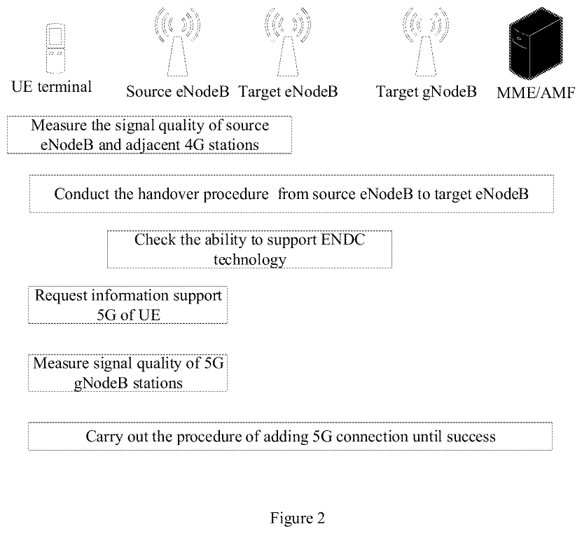

Within the scope of the invention, the guarantee conditions of the method is the eNodeB can exchange control/data signals with UE and carry out normal procedures based on 4G technology. FIG. 2 reference describes an overview of the inventory method. Specifically:

Step 1: Measure the Signal Quality of Source eNodeB Neighbors and Select a Target eNodeB to Handover.

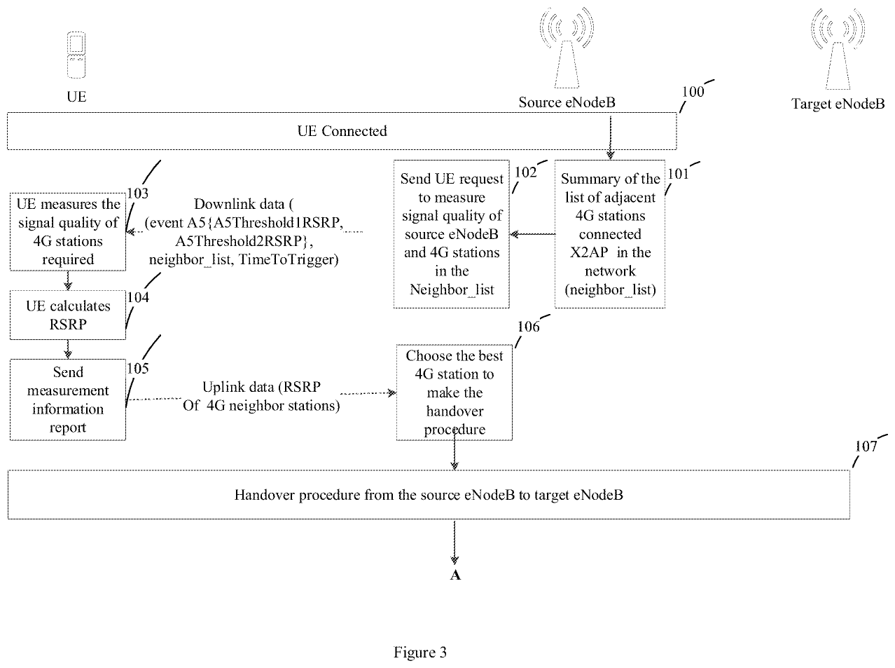

UE is in a state of “UE CONNECTED” with the source eNodeB station. Through the A5 event, the source eNodeB sent a list of frequencies that require UE to measure the quality of RSRP/RSRQ signals to decide whether handover procedures. FIG. 3 detailed Step 1 as follows:

At the Source eNodeB Station:
The list of adjacent 4G stations connected to network-block (101): This block will automatically save the list of eNodeB neighbors connected to the source eNodeB station. Each eNodeB neighbor station will include the following sets of information:
   Operating frequency information of 4G station;
   PhyCellID: The identification code of the station;

In particular, the operating frequency information of neighbor stations will be the input of the block (102)—request UE to measure the signal quality of the source eNodeB and eNodeB Neighbor;
Block (102)—sends UE a request to measure signal quality of source eNodeB and 4G stations in the list (101). Set of information sends to UE include:

### For A5 Event:

a5Threshold1Rsrp, a5Threshold2Rsrp: the upper and lower threshold level;
Station frequency fequency information;
Activated cycle: enough time for measurement information that UE provides meaning;
   The outputs of the block (102) are combine in the “RRC connection configuration” newsletter and transmitted it on the downlink channel.

### At UE:

Receiving the “RRC connection configuration” newsletter containing information requiring signal quality measurement, the UE will get the measurement request as an input of the signal quality block (103).
Signal quality measurement—block (103): This block will measure the signal quality of the 4G stations required.
The RSRP calculation—block (104): RSRP (Reference Signal Receive Power) is the average capacity received of each resource element at the considered frequency.
Sending the measurement information report—block (105): UE sends information {RSRP, PhyCellID} in the news “Complete the RRC connection configuration” on the upgrade data channel for the powerb station.
   At Source eNodeB Station:

Selection of a target eNodeB—block (106): Receive information {RSRP, PhyCellID} at each frequency satisfying the conditions of activating the event A5. The source eNodeB selects a target eNodeB that is highest RSRP.

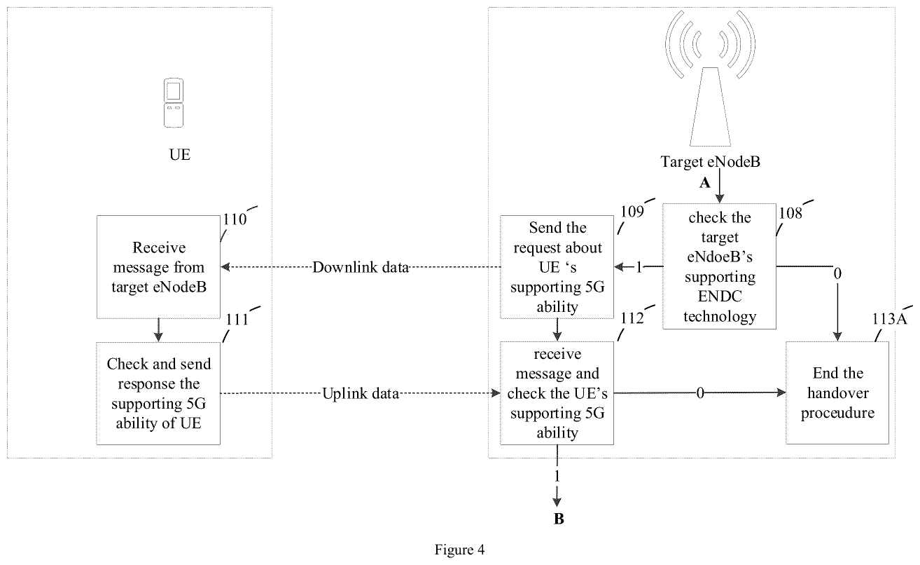

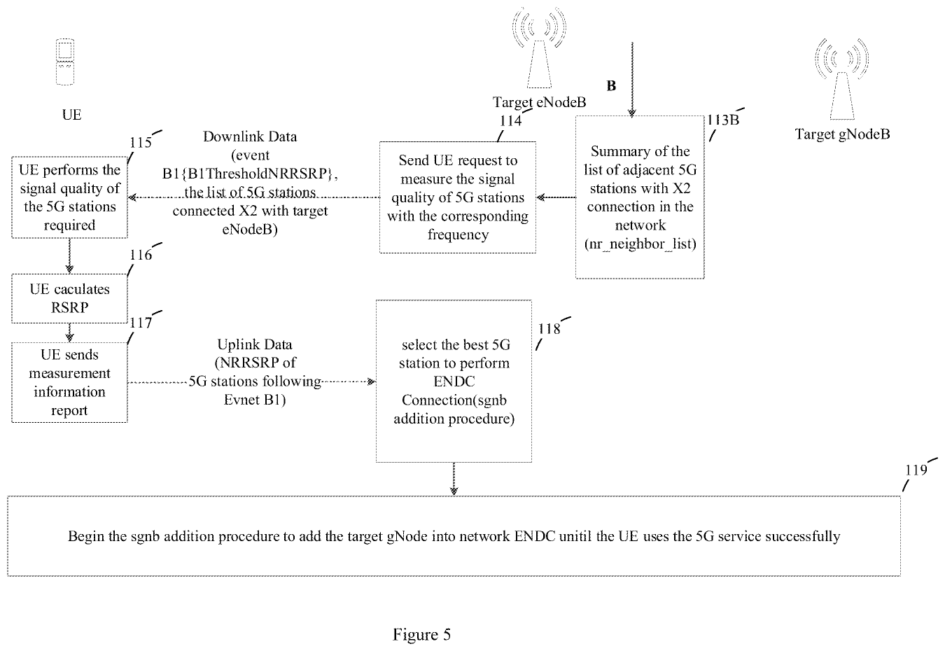

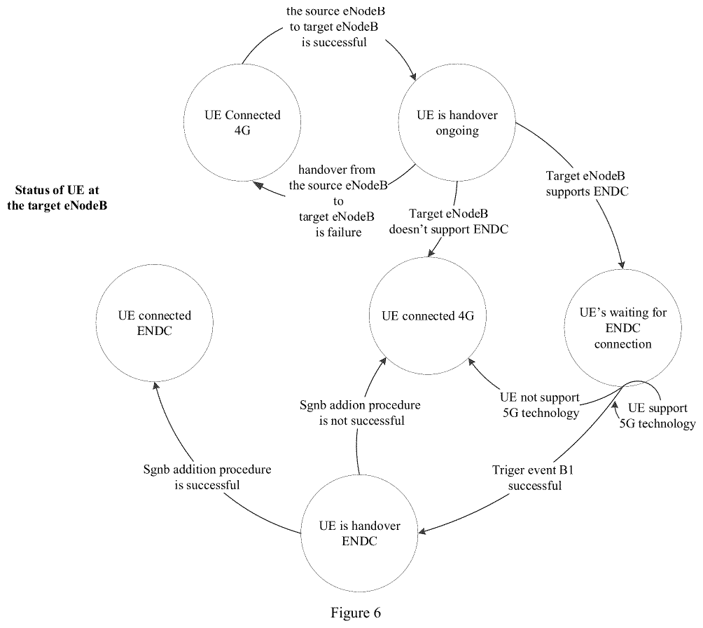

Step 2: The Source eNodeB Station Activates the UE Handover Procedure to the Target eNodeB Station.
FIG. 4 and FIG. 6 describe the step.
Handover procedure—block (107):
   After determining the target eNodeB station, the source eNodeB will activate the handover procedure for the UE. At this time, the whole configuration of the UE is set at the target eNodeB station, and the UE at source eNodeB will be released. The UE connects a successful signal to the target eNodeB station. At this time, the status of UE at the target eNodeB is still “UE is handover ongoing” (not at state at “UE Connected 4G” as normal case).
Determine the ability to support the ENDC of the target eNodeB—block (108):
   This block will check the dual connection ability of the target eNodeB, if:
Do not support ENDC: move UE to the state of “UE connected 4G” and finish the handover procedure;
Else Support ENDC: move UE to the state of “UE waiting for ENDC connection” and go to step 3.
   Step 3: the Target eNodeB Station Chooses gNodeB Station.
   FIG. 4, FIG. 5 and FIG. 6 describe this step.
   At Target eNodeB Station
Require 5G support information of UE—block (109): When knowing that the 4G station supports the ENDC mode, the station will request UE to provide information about the supporting 5G technology ability. This requirement is combine in the “UE Capability Enquiry” newsletter and sends on downlink channel.

### At UE Terminal:

Receiving data, UE proceeded to decode and dissect the packet — block (110);
UE checked its 5G support capacity and sent a response to the eNodeB station with the “UE Capability Information Indication” newspaper on uplink channel — block (111).
   At the Target eNodeB Station:
Determine the ability to support 5G of the UE — block (112): Determine the ability to support 5G technology of UE.
   If UE does not support 5G technology, the target eNodeB will finish handover procedure completely—block (113A): This block will move UE's state to “UE connected 4G” and finish the handover procedure;
   If UE supports the 5G technology, UE in the state of “UE's waiting for ENDC connection”. Go to the listing neighbor 5G—block (113B);
List neighbor 5G—block (113B): the target eNodeB station summaries the list of neighbor 5G stations with the activated X2 connection in the network, including the set of information:
   NRCellIdentity: 5G station identification code;
   NRFreqBand: used bands of 5G station;
   NRArfcn: operating frequency of 5G station.

Information pair (B1ThresholdNrRsrp, NRArfcn): is the input of the activation event B1—lock (114).
Activate event B1—block (114): This block will send UE a request to measure the signal quality of the target eNodeB station and gNodeB stations with the corresponding frequency (B1 thresholdnRSRP, NRARFCN), and it activates event B1. This requirement will be combine in the “RRC connection configuration” on the downlink channel.

### At UE Terminal:

Measure the quality of the frequency signal 5G —block (115): Receive a request message, UE performs signal quality measurement at the required 5G frequencies;
Calculate the RSRP—block (116): calculate the RSRP of signal at the required frequencies; Send the measurement information report—block (117): When RSRP at frequency f>B1 thresholdNrRsrp continuously in a period of “trigger cycle” time, UE will send reports to target eNodeB station the set of information {NRPhyCell, NRRsrp} of frequency f. This information will be combine in the message “RRC Connection Reconfig Complete” on the uplink channel.
   At the Target eNodeB
The best 5G station selection block to carry out the procedure of connecting ENDC—block (118): the target eNodeB station receives the set of information {NRPhyCell, NRRsrp} at frequency {f1, f2, . . . } respectively. After that, it performs the selecting 5G station for satisfying the connecting condition: RSRP of the target station is the best. Move the UE to the state “UE is handover ENDC”.
   Step 4: The eNodeB Station Conduct the Sgnb Addition Procedure with Target gNodeB.
   FIG. 5 and FIG. 6 describe this step:
The block carried out the sgnb addition procedure with target gNodeB-block (119): The target gNodeB will be add to the network by the target eNodeB through the SGNB Addition Procedure according to 3GPP standards.
   If this procedure is successful, UE will move to the status “UE connected ENDC”. At this time, UE will exchange information to signal via target eNodeB station and use 5G data via target gNodeB station.
   If this procedure fails, UE will move to the state of “UE connected 4G”. UE will exchange signals and data via target eNodeB (completely 4G technology).

### EXAMPLE OF THE INVENTION

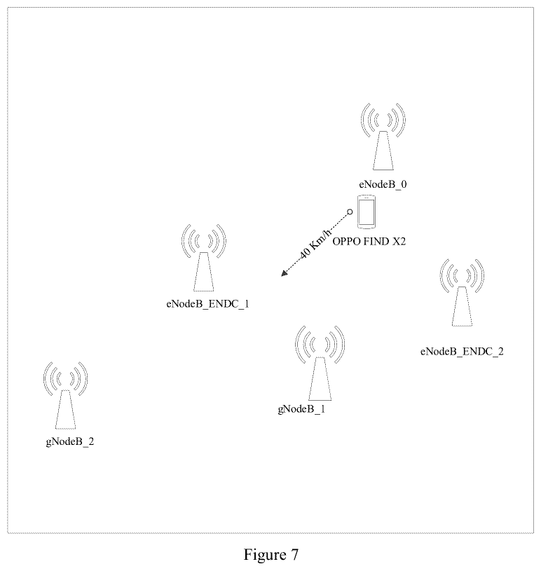

To prove the effectiveness of the patent, the authors have applied the invention into the integration of hardware on the high frequency broadcasting device 4G and 5G produced by VHT-Viettel. The model described in FIG. 7. The components of the system include:
The 4G core network emulation system, the EPC Emulator selection of Polaris, simulates the function and business of both network entities on EPC side, EPC Emulator system can support over 1200 UE in a cell and 3600 UE in an eNodeB;
Viavi's 5G core network emulation system, S-GW of Viavi, simulating functions and operations of network entities on the S-GW side, S-GW Viavi system can support 1000 UE;
Source eNodeB station: eNodeB VHT-Viettel, this is a 4G station manufactured by Viettel EVT2 series that has been widely implemented in Vietnam, Cambodia and East Timo markets.
Target eNodeB station: eNodeB Endc VHT-Viettel, this is a 4G station that supports ENDC technology manufactured by Viettel has been implemented in Hanoi;

In this actual testing example, we using a eNodeB Viettel-VHT station (referred to as ENODEB_0) and two 4G ENDC eNodeB Viettel-VHT stations (referred to as eNodeB_ENDC_1 and eNodeB_ENDC_2) are structured: Including a signal control and Concentrate Component (CTC), three Baseband Component (BBC), three Remote Radio Units (RRU), three antennas:
The CTC here selects the T2080 processor (T2080 Processor) of the NXP. This processor contains eight cores (Core) E6500 dedicated to handling signal control and data transmission. Specifically, CTC will implement CSM, OAM and GTPU software programs;
BBC here selects the B4860 processor (B4860 Processor) of NXP, this processor contains eight E6500 and six Starcores SC3900FP DSPS, specialized for high -speed data transport processing and signal processing Physical classroom root. Specifically, BBC will declare L2 and L1 software programs.
gNodeB station: 5G gNodeB VHT-VIETTEL manufactured by Viettel;

Authors establish two gNodeB stations VHT-VIETEL (referred to as gNodeB_1, gNodeB_2) with a hardware structure including the distribution unit block (DU), concentrated unit (CU) and Remote Radio Unit (RRU). DU and CU base on the Intel processor (R) Xeon (R) Gold 6342 CPU 2.8 GHz of Intel. This processor has 24 core (Core), 48 specialized threads. Currently, VHT uses CU to handle signal control operations and processing physical-class orchids, traveling with high-speed data transport operations.
the terminal UE is Oppo Findo X2 series—The line that supports 5G technology platform; The configuration parameters for the system, information of cells belonging to eNodeB, eNodeB ENDC and 5G gNodeB describe below:

TABLE 1
The system configuration parameters of 4G stations

| | eNodeB_0 | | eNodeB_ENDC_1 | | eNodeB_ENDC_2 | |
|---|---|---|---|---|---|---|
| signal | 20 | MHz | 20 | MHz | 20 | MHz |
| bandwidth | | | | | | |
| Signal | band 3 (1805 | | band 3 (1805 | | band 3 (1805 | |
| Band | MHz-1880) | | MHz-1880) | | MHz-1880) | |
| number of | 1 cell | | 1 cell | | 1 cell | |
| cell/station | | | | | | |
| power of | 40 | dBm | 50 | dBm | 30 | dBm |
| base station | | | | | | |

TABLE 2
The system configuration parameters of 5G stations

| | |
|---|---|
| gNodeB_1 | gNodeB_2 |

| | | | | |
|---|---|---|---|---|
| signal bandwidth | 20 | MHz | 20 | MHz |

| | | |
|---|---|---|
| Signal Band | band 78 (3330 | band 78 (3330 |
| | MHz-3800 MHz) | MHz-3800 MHz) |

| | | | | |
|---|---|---|---|---|
| number of cell/station | 1 | cell | 1 | cell |
| power of base station | 40 | dBm | 35 | dBm |

TABLE 3
The box configuration parameters are operating at 4G stations

| | | Configuration | | Configuration | | Configuration | |
|---|---|---|---|---|---|---|---|
| | Meaning of | of cell0 | | of cell 0 | | of cell 0 | |
| Parameter | parameter | eNodeB_0 | | eNodeB_ENDC_1 | | eNodeB_ENDC_2 | |
| PhyCellID | Physical Cell | 147 | | 148 | | 149 | |
| | Identity | | | | | | |
| Freq_DL | downlink | 1855 | MHz | 1875 | MHz | 1835 | MHz |
| | center | | | | | | |
| | frequency | | | | | | |
| Freq_UL | uplink center | 1760 | MHz | 1780 | MHz | 1740 | MHz |
| | frequency | | | | | | |
| A5Threshold1RSRP | threshold 1 | −85 | dBm | −85 | dBm | −85 | dBm |
| | of RSRP for | | | | | | |
| | A5 event | | | | | | |
| A5Threshold2RSRP | threshold 2 | −80 | dBm | −80 | dBm | −80 | dBm |
| | of RSRP for | | | | | | |
| | A5 event | | | | | | |
| hysteresis | timing delay | 0 | dBm | 0 | dBm | 0 | dBm |
| TimeToTrigger | time to | 320 | ms | 320 | ms | 320 | ms |
| | trigger event | | | | | | |
| B1ThresholdNrRsrp | threshold of | −127 | dBm | −127 | dBm | −127 | dBm |
| | RSRP for B1 | | | | | | |
| | event | | | | | | |

TABLE 4
The box configuration parameters are operating at 5G stations

| | | configuration | Configuration |
|---|---|---|---|
| | Meaning of | of cell 0 | of cell 0 |
| Parameter | parameter | gNodeB_1 | gNodeB_2 |
| NRPhyCellID | NR Physical Cell | 1 | 2 |
| | Identity | | |
| NR_Freq | Center frequency | 3633, 4199 MHz | 3602, 0149 MHz |
| | of gNodeB | | |

The adjacent stations eNodeB_0 are eNodeB_ENDC_1 and eNodeB_ENDC_2 stations. eNodeB_ENDC_1 station has an X2 connection with two gNodeB_1 and gNodeB_2 stations. eNodeB_ENDC_2 also has an X2 connection with two gNodeB_1 and gNodeB_2 stations.
Oppo Find X2 accesses and uses the service at eNodeB_0 station, then move away from the 4G station with 40 km/h and approach eNodeB_ENDC_1 station
eNodeB_0 sends a request to measure the quality of RSRP signal of eNodeB_0 and signal quality at frequency of 1875 MHz (eNodeB_ENDC_1) and frequency of 1835 MHz (eNodeB_ENDC_2) together with the parameter used to activate A5 {eventA5, A5Threshold1RSRP, A5Threshold2RSRP, hysteresis, TimeToTrigger . . . }
UE OPPO received RSRP signal quality requirements from eNodeB_0 station. Perform measurements at the frequencies that eNodeB_0 offers, the results as the following table:

TABLE 5
Station configuration parameter

| | | Configuration | | Configuration | | Configuration | |
|---|---|---|---|---|---|---|---|
| | Meaning of | of cell0 | | of cell 0 | | of cell 0 | |
| Parameter | parameter | eNodeB_0 | | eNodeB_ENDC_1 | | eNodeB_ENDC_2 | |
| PhyCellID | Physical Cell | 147 | | 148 | | 149 | |
| | Identity | | | | | | |
| Freq_DL | downlink | 1855 | MHz | 1875 | MHz | 1835 | MHz |
| | center | | | | | | |
| | frequency | | | | | | |
| RSRP | RSRP of | −90 | dBm | −78 | dBm | −83 | dBm |
| | received | | | | | | |
| | signal at UE | | | | | | |

With the condition of activating the A5 event, and based on the configuration eNodeB_0 sent to UE. UE will decide to send to eNodeB_0 the information {RSRP, PhyCellID}, satisfy the A5 event.
The eNodeB received its signal quality information and eNodeB_ENDC_1, eNodeB_ENDC_2 stations, select eNodeB_ENDC_1 as the target eNodeB station to perform handover procedure.
After handover successful, UE connects to eNodeB_ENDC_1. This target eNodeB station will check the ENDC supporting ability and connection to 5G stations by X2AP interface. If the eNodeB satisfies these conditions, the eNodeB_ENDC_1 conducts procedure to ask capability of OPPO FIND X2 (UE).
Because UE oppo Find X2 is capable of supporting 5G technology, it will reply to eNodeB_ENDC_1 this information. eNodeB_ENDC_1 receives this information, will send a request for measuring the B1 event for UE including information at the value pair {3633.4199 MHz, 3602.0149 MHz, B1thresholdNrRsrp};
UE receives the signal quality measurement request at frequency of 3602.0149 MHz/3633.4199 MHz. The quality of RSRP UE signal is continuously measured at this frequency for a period of time greater than the threshold of B1thresholdNrRsrp. UE decided to send information {NRPhyCellID, NRRsrp} at the corresponding frequency according to Table 6:

TABLE 6
The actual station configuration parameter of 5G stations

| | Meaning of | | | | |
|---|---|---|---|---|---|
| Parameter | parameters | gNodeB_1 | | GNodeB_2 | |
| NRPhyCellID | NR Physical Cell | 1 | | 2 | |
| | Identity | | | | |
| Freq_DL | downlink center | 3633, 4199 | MHz | 3602, 0149 | MHz |
| | frequency | | | | |
| NRRsrp | received signal | −102 | dBm | −115 | dBm |
| | power | | | | |

eNodeB_ENDC_1 received a measurement report from UE. Perform 5G station selection of the best signal quality (gNodeB_1) to carry out the 5G parallel connection procedure.
eNodeB_ENDC_1 performed the connection procedure to the gNodeB_1 station until the UE can use the 5G service and keep the connection signaling with 4G.

### Testing Results:

The transfer procedure from Enodeb VHT-Viettel (not support Endc) to eNodeB ENDC VHT-Viettel and connects to 5g gNodeB VHT-Viettel are successful. UE connects the signal to the Enodeb Endc VHT-Viettel and uses the 5G service via 5G gNodeB VHT-Viettel device.

### The Benefits Achieved by the Invention

The method is feasible, easy to apply and make the most of the existing hardware equipment, saving development time. The actual implementation of the method has shown the ability to UE using 5G technology service in parallel with a stable 4G connection. Fast growing time, optimization of costs and ensuring very low call drop rate are the outstanding benefits of inventions that bring carriers who want to take advantage of the available 4G platform and can still provide 5G service for users.

What is claimed is:

1. A method of maintaining radio connectivity and 5G service of user equipment (UE) during the transfer from the 4G technology base station (source eNodeB station) to a target base station (target eNodeB station) which will be connected to the 5G technology base station (gNodeB station) on the dual -connected mobile technology platform (Dual Connectivity) in the 4^{th} and 5^{th} generation, comprising the steps of:
Step 1: Measure a signal quality of source eNodeB neighbors and select a target eNodeB to handover;
UE is in a state of “UE CONNECTED” with the source eNodeB station, through the A5 event, the source eNodeB sends a list of frequencies that require UE to measure the quality of RSRP/RSRQ signals to decide whether handover procedures, as follows:
At the source eNodeB station:
The list of adjacent 4G stations connected to networkblock: This block automatically saves the list of eNodeB neighbors connected to the source eNodeB station; Each eNodeB neighbor station includes the following sets of information:
Operating frequency information of 4G station;
PhyCellID: The identification code of the station;
In particular, the operating frequency information of neighbor stations is the input of the UE request block—request UE to measure the signal quality of the source eNodeB and eNodeB Neighbor;
UE request block—sends UE a request to measure signal quality of source eNodeB and 4G stations in the list; Set of information sent to UE include:
For A5 event:
a5Threshold1Rsrp, a5Threshold2Rsrp: the upper and lower threshold level;
Station frequency frequency information;
Activated cycle: enough time for measurement information that UE provides meaning;
The outputs of the UE request block are combined in the “RRC connection configuration” newsletter and transmitted on a downlink channel;
At UE:
Receiving the “RRC connection configuration” newsletter containing information requiring signal quality measurement, the UE gets the measurement request as an input of the signal quality measurement block;
Signal quality measurement block: This block measures the signal quality of the 4G stations required;
The RSRP calculation block: RSRP (Reference Signal Receive Power) is the average capacity received of each resource element at the considered frequency;
Sending the measurement information report block: UE sends information {RSRP, PhyCellID} in the news “Complete the RRC connection configuration” on the upgrade data channel for the powerb station;
At source eNodeB station:
Selection of a target eNodeB block: Receive information {RSRP, PhyCellID} at each frequency satisfying the conditions of activating the event A5; The source eNodeB selects a target eNodeB that is highest RSRP;
Step 2: the source eNodeB station activates the UE handover procedure to the target eNodeB station;
Handover procedure block:
After determining the target eNodeB station, the source eNodeB activates the handover procedure for the UE; At this time, the whole configuration of the UE is set at the target eNodeB station, and the UE at source eNodeB is released; The UE connects a successful signal to the target eNodeB station; At this time, the status of UE at the target eNodeB is still “UE is handover ongoing” (not at state at “UE Connected 4G” as normal case);
Determine the ability to support the ENDC of the target eNodeB block:
This block checks the dual connection ability of the target eNodeB, if:
Do not support ENDC: move UE to the state of “UE connected 4G” and finish the handover procedure;
Else Support ENDC: move UE to the state of “UE waiting for ENDC connection” and go to step 3
Step 3: the target eNodeB station chooses gNodeB station;
At target eNodeB station
Require 5G support information of a UE block: When knowing that the 4G station supports the ENDC mode, the station requests UE to provide information about the supporting 5G technology ability; This requirement is combined in the “UE Capability Enquiry” newsletter and sent on the downlink channel;
At UE terminal:
Receiving data, UE proceeded to decode and dissect a packet block;
UE checks its 5G support capacity and sends a response to the eNodeB station with the “UE Capability Information Indication” newspaper on an uplink channel block;
At the target eNodeB station:
Determine the ability to support 5G of the UE block: Determine the ability to support 5G technology of UE;
If UE does not support 5G technology, the target eNodeB will finish handover procedure completely block: This block moves UE's state to “UE connected 4G” and finishes the handover procedure;
If UE supports the 5G technology, UE is in the state of “UE's waiting for ENDC connection”; Go to listing neighbor 5G block;
Listing neighbor 5G block: the target eNodeB station summaries the list of neighbor 5G stations with the activated X2 connection in the network, including the set of information:
NRCellIdentity: 5G station identification code;
NRFreqBand: used bands of 5G station;
NRArfcn: operating frequency of 5G station;
Information pair (B1ThresholdNrRsrp, NRArfcn): is the input of the activation event B1 block
Activation event B1 block : This block sends UE a request to measure the signal quality of the target eNodeB station and gNodeB stations with the corresponding frequency (B1thresholdnRSRP, NRARFCN), and it activates event B1; This requirement is combined in the “RRC connection configuration” on the downlink channel;
At UE terminal:
Measure the quality of the frequency signal 5G block: Receive a request message, UE performs signal quality measurement at the required 5G frequencies;
Calculate the RSRP block: calculate the RSRP of signal at the required frequencies;
Send the measurement information report block: When RSRP at frequency f>B1thresholdNrRsrp continuously in a period of “trigger cycle” time, UE sends reports to target eNodeB station the set of information {NRPhyCell, NRRsrp} of frequency f; This information is combined in the message “RRC Connection Reconfig Complete” on the uplink channel;
At the target eNodeB
The best 5G station selection block to carry out the procedure of connecting ENDC block : the target eNodeB station receives the set of information {NRPhyCell, NRRsrp} at frequency {f1, f2, . . .} respectively; After that, it performs the selecting 5G station for satisfying the connecting condition: RSRP of the target station is the best; Move the UE to the state “UE is handover ENDC”;
Step 4: the eNodeB station conduct the sgnb addition procedure with target gNodeB;
The block carries out the sgnb addition procedure with target gNodeB block: The target gNodeB ise add to the network by the target eNodeB through the SGNB Addition Procedure according to 3GPP standards:
If this procedure is successful, UE moves to the status “UE connected ENDC”; At this time, UE exchanges information to signal via target eNodeB station and uses 5G data via target gNodeB station;
If this procedure fails, UE moves to the state of “UE connected 4G”, UE exchanges signals and data via target eNodeB (completely 4G technology).
